(19) United States
(12) Patent Application Publication
(10) Pub. No.: US 2012/0097260 A1
(43) Pub. Date: Apr. 26, 2012

(54) AIRCRAFT COVER INCLUDING MEANS FOR LIMITING THE SCOOP PHENOMENA OF ELECTROMAGNETIC TYPE

(75) Inventors: Alain PORTE, Colomiers (FR); Frédéric CHELIN, Encausse (FR); Etienne BERTIN, Toulouse (FR)

(73) Assignee: AIRBUS OPERATIONS (S.A.S), Toulouse (FR)

(21) Appl. No.: 13/276,489

(22) Filed: Oct. 19, 2011

(30) Foreign Application Priority Data
Oct. 26, 2010 (FR) 10 58783

(51) Int. Cl. F02K 99/00

(52) U.S. Cl. 137/15.1

(57) ABSTRACT

An aircraft nacelle includes at its outside wall a cowl that can move relative to the rest of the nacelle so as to block or unblock an opening. The cowl includes an articulation relative to the rest of the nacelle and locking/unlocking elements distant from the upstream edge of the cowl that includes elements for limiting the appearance of scooping phenomena. The limiting elements include at least one electromagnetic torque, having one element integral with the rest of the nacelle and the other element integral with the cowl, with at least one of these two elements emitting a magnetic field that generates a force of attraction on the other element, and the surfaces of the two elements of the electromagnetic torque that are flattened against one another are arranged in planes having at least one component in the radial direction.

This invention relates to an aircraft cowl that incorporates means for limiting magnetic-type scooping phenomena.

An aircraft propulsion system comprises a nacelle in which a power plant that is connected by means of a mast to the rest of the aircraft is arranged in an essentially concentric manner.

The nacelle comprises an inside wall that delimits a pipe with an air intake at the front, with a first part of the incoming air stream, called the primary stream, passing through the power plant to take part in the combustion process, and with the second part of the air stream, called the secondary stream, being entrained by a fan and flowing into an annular pipe that is delimited by the inside wall of the nacelle and the outside wall of the power plant.

The nacelle also comprises an outside wall with an essentially circular cross-section that extends from the air intake to the aft exhaust, constituted by the juxtaposition of several elements, an essentially rigid air intake at the front followed by nacelle doors, also called cowls.

The air intake is rigid because of its curved shapes and numerous reinforcements for withstanding forces generated by the aerodynamic flows or possible shocks.

The cowls are made mobile to allow access to the power plant that is placed inside the nacelle. These cowls are articulated with the rest of the nacelle in different manners based on the kinematics adopted, and they extend from the top of the nacelle, close to the anchoring of the mast, up to the bottom of the nacelle and have a semi-cylindrical shape.

A cowl generally comprises a piece of sheet metal with stiffeners on the inside surface to impart a relative rigidity thereto. The smooth outside surface of the cowl is sensitive to remaining in the extension of the outside surface of the other elements, in particular of the air intake, when the cowl is in the closed position.

Locking means are provided at the lower edge of the cowl so as to keep the cowl in the closed position.

In addition, the frame of the opening that is blocked by the cowl comprises—on at least a part of its periphery—a contact surface against which the cowl can rest in such a way as to always keep its outside surface in the extension of that of the air intake.

Optionally, the contact surface of the frame can comprise a deformable element such as a compressible joint.

To ensure a positioning of the cowl relative to the rest of the nacelle along the longitudinal axis that also corresponds to the pivoting axis of the cowl, and at the upstream and downstream edges (perpendicular to the pivoting axis) of the frame of the opening, it is possible to provide shapes that complement the shapes provided at the upstream and downstream edges of the cowl. Thus, the upstream (and/or downstream) edge of the frame comprises a groove, and the upstream (and/or downstream) edge of the cowl comprises a projecting shape that is housed in the groove that is provided at the frame. These elements make it possible to guide the cowl during its closing in such a way that it is correctly positioned along the pivoting axis when it is closed.

During flight, considering their relative rigidities, the cowls can become deformed, in particular in the radial direction, although the air can penetrate under said cowls into the interior of the nacelle at the junction with the air intake. This scooping phenomenon reduces the aerodynamic performance levels of the aircraft, in particular by increasing the drag, which is manifested as excessive fuel consumption.

So as to limit this phenomenon, one approach consists in increasing the number of stiffeners provided at the cowls. However, this approach goes against the desired result to the extent that the addition of stiffeners contributes to increasing the on-board weight and therefore the consumption of the aircraft.

According to another alternative, it is possible to provide a belt system as illustrated in the patent application FR-2,933,957.

This invention proposes an alternative to the approaches of the prior art that limits the scooping phenomena, without significantly increasing the on-board weight and the maintenance costs.

For this purpose, the invention has as its object an aircraft nacelle that at its outside wall comprises a cowl that can move relative to the rest of the nacelle in such a way as to block or unblock an opening, whereby said cowl comprises an articulation relative to the rest of the nacelle and locking/unlocking means distant from the upstream edge of said cowl that comprises means for limiting the appearance of scooping phenomena, characterized in that said means for limiting the appearance of the scooping phenomenon comprise at least one electromagnetic torque, one element of which is integral with the rest of the nacelle and the other element of which is integral with the cowl, with at least one of the two elements emitting a magnetic field that generates a force of attraction on the other element and in that the surfaces of the two elements of the electromagnetic torque that are flattened against one another are arranged in planes having at least one component in the radial direction.

This arrangement makes it possible to limit the appearance of the scooping phenomenon even if the cowl is not correctly closed.

Other characteristics and advantages will emerge from the following description of the invention, a description that is provided only by way of example, relative to the accompanying drawings in which:

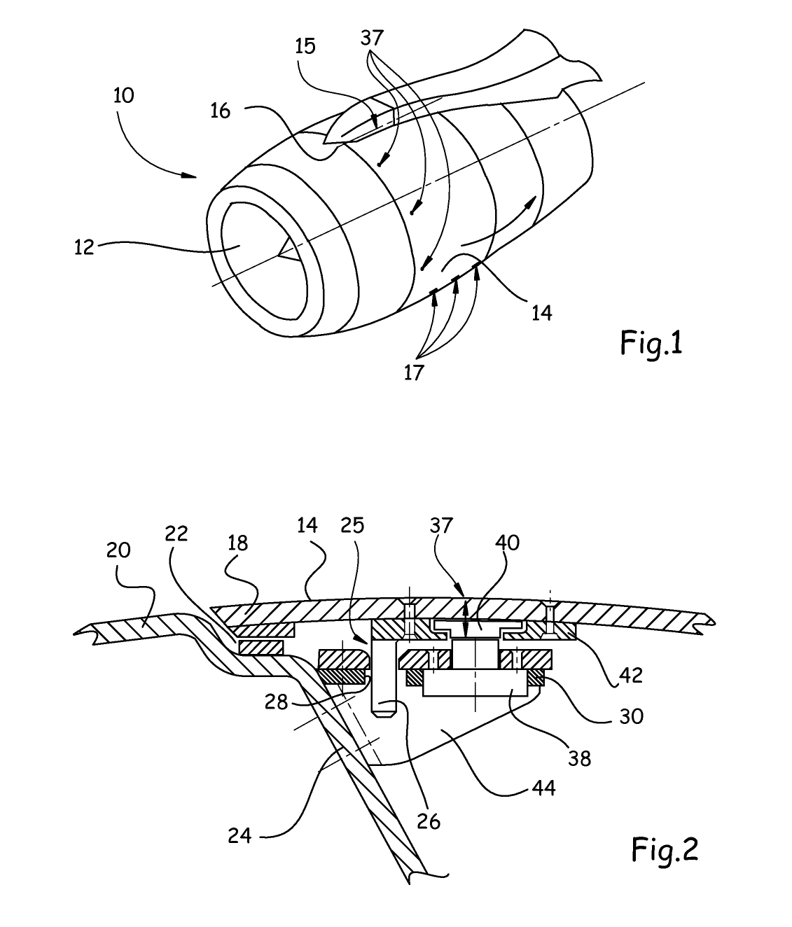

FIG. 1 is a perspective view that illustrates an aircraft nacelle,

FIGS. 2 to 5 are cutaways that illustrate variants of the invention,

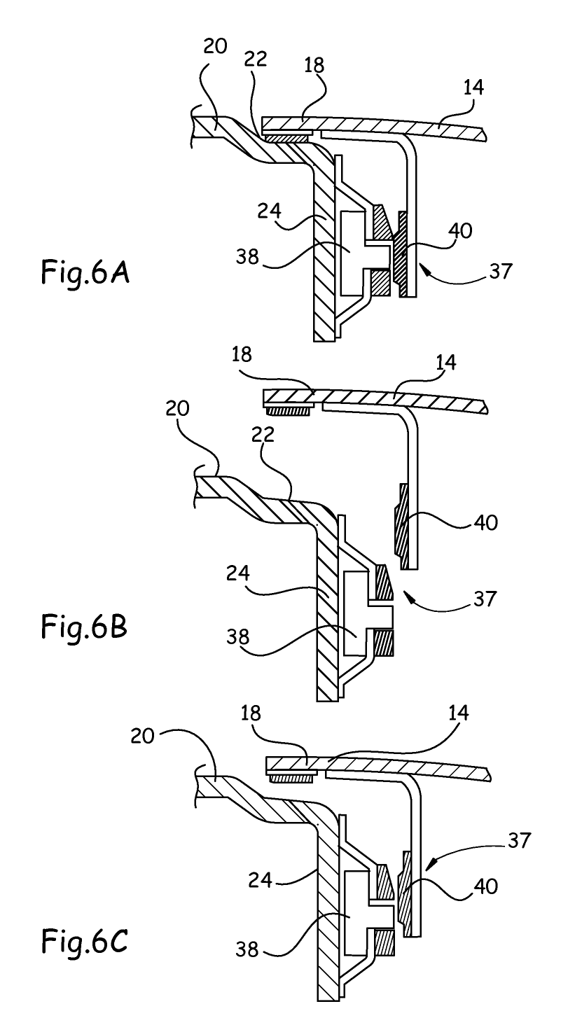

FIG. 6A is a cutaway that illustrates another variant of the invention in a first closed state,

FIG. 6B is a cutaway that illustrates the variant of FIG. 6A in a second so-called open state, and

FIG. 6C is a cutaway that illustrates the variant of FIG. 6A in a third so-called “poorly-closed” state.

FIG. 1 shows a nacelle 10 that contains a power plant and is connected to the rest of the aircraft by a mast. It comprises an outside wall with an essentially circular cross-section that extends from an air intake 12 to an aft exhaust, constituted by the juxtaposition of several elements, with an essentially rigid air intake 12 at the front followed by nacelle doors 14, also called cowls.

The cowls 14 comprise an articulation 15 relative to the rest of the nacelle to make them mobile and to allow access to the power plant. Thus, these cowls 14 make it possible to block or unblock an opening that is delimited by a frame.

These cowls 14 are articulated with the rest of the nacelle in different manners based on the kinematics adopted, and they extend from the top of the nacelle, close to the anchoring of the mast, to the bottom of the nacelle and have a semi-cylindrical shape.

A cowl 14 generally comprises a piece of sheet metal with stiffeners on the inside surface to impart a relative rigidity thereto. The smooth outside surface of the cowl is sensitive to remaining in the extension of the outside surface of the other elements, in particular of the air intake, when the cowl is in the closed position.

Hereinafter, the longitudinal direction corresponds to the direction of the axis of rotation of the fan of the power plant. A vertical median plane corresponds to a vertical plane that contains the longitudinal axis.

A radial direction is a direction that is perpendicular to the longitudinal direction.

A tangential plane at a given point corresponds to a plane that is perpendicular to the radial direction that passes through said point.

The upstream and downstream positions are defined with reference to the direction of the flow of gases inside the power plant.

According to one embodiment, a nacelle comprises two cowls 14 that are symmetrical relative to the vertical median plane of the nacelle, with each cowl being able to pivot around an axis of rotation 16 that is oriented in the longitudinal direction and arranged close to the mast (approximately at 12 o'clock).

Thus, the cowls can occupy several states, namely a closed state (FIG. 6A) in which the outside surfaces of the cowls are arranged in the extension of the surfaces of the parts of the nacelle that are upstream and downstream from the cowls, and an open state (FIG. 6B) in which the cowl to pivot allows access to the power plant.

The lower edges of the cowls are essentially parallel to the pivoting axes 16 and are connected to one another in the closed state by locking/unlocking means 17.

The nacelle, the cowl(s), and the articulation of the cowl relative to the rest of the nacelle, and the locking/unlocking means of the cowl are not described in more detail because they are known to one skilled in the art.

The upstream and downstream edges of the cowl connect the lower and upper edges of the cowl.

These upstream and downstream edges work with the upstream and downstream edges of the frame of the opening. Positioning and guiding means can be provided to position the upstream (or downstream) edge of the cowl correctly with the upstream (or downstream) edge of the opening, for example, a V-shaped groove at the edge of the opening that works with a slot that is provided at the edge of the cowl or blades provided at the edge of the cowl that work with housings provided at the edge of the opening.

FIGS. 2 to 5, 6A, 6B and 6C show in a cutaway—in a plane that contains the longitudinal axis of the power plant—the upstream edge 18 of the cowl that works with the upstream edge 20 of the opening. The latter comprises an offset 22 that makes it possible to house the end of the edge 18 of the cowl in such a way that the outside surface of the cowl is arranged in the extension of the outside surface of the rest of the nacelle.

The opening is delimited by a frame that comprises a wall 24 at the upstream edge that is perpendicular or tilted relative to the outside surfaces of the nacelle.

According to the variants that are illustrated in FIGS. 2, 3 and 4, the cowl 14 comprises means 25 for positioning it relative to the opening.

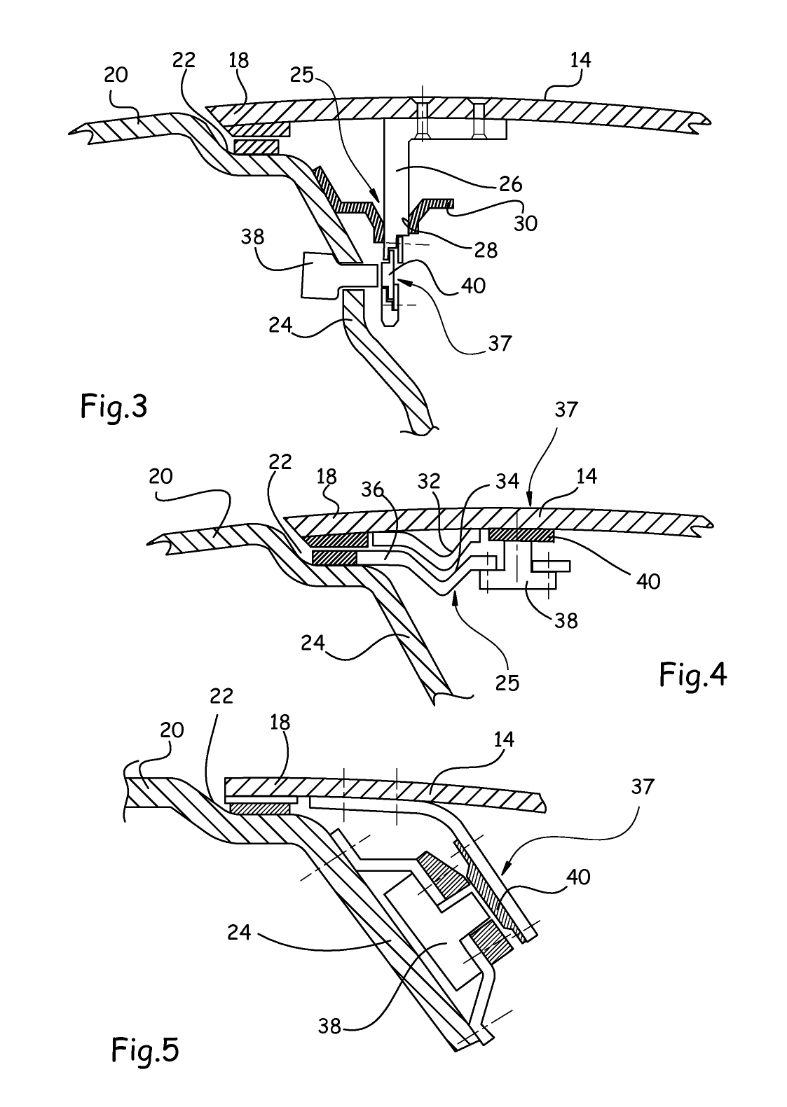

According to a variant that is illustrated in FIGS. 2 and 3, the cowl comprises a projecting shape 26 called a blade that works with a housing 28 that is integral with the rest of the nacelle. According to one embodiment, the housing 28 comes in the form of an opening that is made in a plate 30 that is integral with the wall 24 that delimits the opening. The blade 26 comes in the form of a cylinder. Based on the position of the blade 26 on the upstream edge of the cowl, said blade 26 has a curved shape to work with the opening 28 during the pivoting movement of the cowl.

As required, the upstream edge of the cowl can comprise one or more blades distributed over the length of the edge of the cowl.

According to another variant illustrated in FIG. 4, the cowl can comprise a projecting rib 32 (with a V-shaped cross-section, for example) that extends in a transverse plane (perpendicular to the pivoting axis 16), which works with a groove 34 with a profile that is adapted to that of the projecting rib 32, made at the frame of the opening. According to one embodiment, the groove 34 is made in a plate 36 that is integral with the rest of the nacelle and in particular the upstream edge of the opening.

The rib 32 can extend in a continuous manner over the entire length of the upstream edge of the cowl or come in the form of at least one section that extends over at least a part of the length of the upstream edge of the cowl.

According to the variants that are illustrated in FIGS. 2 to 4, the positioning means 25 make it possible to ensure the positioning of the cowl in the direction of the pivoting axis 16 of the cowl. The invention is not limited to these embodiments. Other approaches can be considered for positioning the cowl relative to the opening.

In all cases, to allow the opening and the closing of the cowl, the positioning means 25 do not ensure the positioning of the cowl relative to the rest of the nacelle in a direction that corresponds to the direction of the opening and closing movement of the cowl that corresponds essentially to the radial direction. Consequently, taking into account the distance between the pivoting axis 16 and the locking/unlocking means 17, the cowl 14 can become deformed in the radial direction and can produce a scooping phenomenon.

So as not to alter its aerodynamic characteristics, the nacelle comprises means 37 for limiting the deformation of the cowl and the appearance of the scooping phenomenon.

According to the invention, the means 37 for limiting the appearance of the scooping phenomenon comprise at least one electromagnetic torque, one element 38 of which is integral with the rest of the nacelle, and the other element 40 of which is integral with the cowl, with at least one of the two elements emitting a magnetic field that generates a force of attraction on the other element.

According to one embodiment, the first element 38 is a permanent magnet.

As a variant, the first element 38 is an electromagnet that generates a magnetic field when it is supplied with electricity. In this case, the means 37 for limiting the appearance of the scooping phenomena can be activated or deactivated.

This approach is preferred because it makes it possible not to activate the means 37 for limiting the appearance of the scooping phenomenon in particular when it is desired to maneuver the cowl and not to activate them when the cowl is in the closed state.

Advantageously, the electromagnet 38 is made integral with the stationary part, namely the rest of the nacelle.

In addition, the second element 40 is made of magnetic material. Each cowl 14 comprises at least one electromagnetic torque. As appropriate, the cowl can comprise several electromagnetic torques that are distributed over the length of the upstream edge of the cowl. Advantageously, the torque(s) is/are arranged in the zones where scooping phenomena can appear, namely close to the zones corresponding to 3 o'clock or 9 o'clock (midway between the pivoting axis and the lower edge of the cowl).

So as to optimize the operation of the electromagnetic torque, it is necessary that the two elements 38 and 40 be correctly positioned relative to one another.

According to a first variant, an electromagnetic torque 38, 40 is positioned close to the positioning means.

According to a first variant that is illustrated in FIG. 2, the positioning means 25 at the cowl comprise a base plate 42 that is attached to the cowl that supports a blade 26 and at the rest of the nacelle comprise a plate 30 with an opening 28 that is made integral by a bracket 44 at the wall 24 of the opening. The electromagnetic torque comprises an electromagnet 38 that is made integral with the plate 30 and a pellet 40 that is made of magnetic material and is integral with the base plate 42.

According to another variant that is illustrated in FIG. 3, one of the elements of the electromagnetic torque is supported by the projecting element 26 of the positioning means. Thus, the blade 26 supports a magnetic pellet 40 that is arranged facing an electromagnet 38 that is made integral with the wall 24 that delimits the opening.

According to another variant that is illustrated in FIG. 4, the magnetic element 40 in the form of a pellet is made integral with the inside surface of the cowl in such a way as to be adjacent to the projecting rib 32. In addition, the rest of the nacelle comprises a plate 36 in which the groove 34 is made and supports the electromagnet 38. Advantageously, said plate 36 is connected at just one edge and comprises an offset part. The plate 36 is made with a thickness and a material that are suitable for being able to slightly bend and to compensate for a poor positioning of the cowl in the radial direction.

So as to correctly position the two elements of the electromagnetic torque relative to one another, the connection between at least one of the two elements 38, 40 and its support (cowl or rest of the nacelle) allows a slight travel that makes it possible to correct a minor misalignment.

As illustrated in FIGS. 2 and 3, the pellet 40 can be arranged in a housing whose dimensions are larger than those of the pellet in such a way that play remains between the edge of the pellet and the housing so that said pellet can move slightly relative to its support.

If appropriate, an electromagnetic torque is arranged close to the positioning means 25, and at least one of the two elements of said electromagnetic torque can move relative to its support.

As a variant, at least one of the two elements of an electromagnetic torque can move relative to its support, and said electromagnetic torque is distant from the positioning means 25, or an electromagnetic torque is arranged close to the positioning means 25, and the two elements of said torque are stationary relative to the supports.

According to another aspect of the invention, the surfaces of the two elements of the electromagnetic torque flattened against one another are arranged in planes that have at least one component in the radial direction.

This arrangement makes it possible to compensate for a possible poor positioning of the two elements in the radial direction.

In the contrary case, if the surfaces of the two elements are arranged in tangential planes and if the air gap (distance separating said surfaces) is too large, the force of attraction between the two elements 38 and 40 may not be adequate for keeping the cowl in position relative to the rest of the nacelle.

According to the embodiments illustrated in FIGS. 3 and 6, the surfaces of the two elements 38 and 40 that face one another are arranged in planes that contain the radial direction.

Thus, as illustrated in FIG. 6C, even if the cowl is poorly closed and the two elements 38 and 40 are not perfectly aligned but are slightly offset in the radial direction, when the electromagnet is activated, it exerts a force of attraction on the pellet that is enough to immobilize the cowl and to limit its deformation and the scooping phenomena.

According to another embodiment, as illustrated in FIG. 5, the surfaces of the two elements 38 and 40 can be arranged in planes that are tilted relative to the radial and longitudinal directions. This configuration makes it possible to compensate for a poor alignment of the elements 38 and 40 in the radial direction and in the longitudinal direction.

Preferably, the surfaces of the two elements 38 and 40 make an angle that is less than 60° relative to the radial direction.

1. Aircraft nacelle (10) that at its outside wall comprises a cowl (14) that can move relative to the rest of the nacelle (10) in such a way as to block or unblock an opening, whereby said cowl (14) comprises an articulation (15) relative to the rest of the nacelle (10) and locking/unlocking means (17) distant from the upstream edge (18) of said cowl (14) that comprises means (37) for limiting the appearance of scooping phenomena, characterized in that said means (37) for limiting the appearance of the scooping phenomenon comprise at least one electromagnetic torque, one element (38) of which is integral with the rest of the nacelle (10) and the other element (40) of which is integral with the cowl (14), with at least one of the two elements (38, 40) emitting a magnetic field that generates a force of attraction on the other element, and in that the surfaces of the two elements (38, 40) of the electromagnetic torque that are flattened against one another are arranged in planes having at least one component in the radial direction.

2. Aircraft nacelle according to claim 1, wherein the surfaces of the two elements (38, 40) make an angle that is less than 60° relative to the radial direction.

3. Aircraft nacelle according to claim 1, wherein one of the two elements of the electromagnetic torque (38, 40) is an electromagnet.

4. Aircraft nacelle according to claim 3, wherein the electromagnet is supported by the rest of the nacelle (10).

5. Aircraft nacelle according to claim 1, wherein at least one of the two elements (38, 40) of an electromagnetic torque can move relative to its support.

6. Aircraft nacelle that at its outside wall comprises a cowl (14) that comprises positioning means (25) at its upstream edge (18) according to claim 1, wherein an electromagnetic torque is arranged close to the positioning means (25).

7. Aircraft nacelle according to claim 6, wherein the positioning means (25) at the cowl (14) comprise a base plate (42) that is attached to the cowl (14) that supports a projecting element (26, 32) that is housed in a hollow element that is integral with the rest of the nacelle (10) and that supports a pellet (40) made of magnetic material.

8. Aircraft nacelle according to claim 2, wherein one of the two elements of the electromagnetic torque (38, 40) is an electromagnet.

9. Aircraft nacelle according to claim 9, wherein the electromagnet is supported by the rest of the nacelle (10).

10. Aircraft nacelle according to claim 2, wherein at least one of the two elements (38, 40) of an electromagnetic torque can move relative to its support.

11. Aircraft nacelle that at its outside wall comprises a cowl (14) that comprises positioning means (25) at its upstream edge (18) according to claim 2, wherein an electromagnetic torque is arranged close to the positioning means (25).
